(19) United States
(12) Patent Application Publication
(10) Pub. No.: US 2006/0159215 A1
(43) Pub. Date: Jul. 20, 2006

(54) Method for detecting a fault of a power module for a control system of a control rod drive mechanism of a nuclear reactor

(76) Inventors: Choon-Kyung Kim, Changwon-si (KR); Jong-Moo Lee, Changwon-si (KR); Seog-Joo Kim, Changwon-si (KR); Soon-Man Kwon, Changwon-si (KR)

Correspondence Address: Robert E. Bushnell, Suite 300, 1522 K Street, N.W., Washington, DC, 20005-1202, US

(21) Appl. No.: 11/253,572

(22) Filed: Oct. 20, 2005

(30) Foreign Application Priority Data
Jan. 19, 2005 (KR) 10-2005-0004833

(51) Int. Cl. G21C 17/00

(52) U.S. Cl. 376/245

(57) ABSTRACT

In a method for detecting a fault of a power module for a control system of a control rod drive mechanism of a nuclear reactor, a fault of the power module is separately detected in a “go” mode, a “hold” mode and a “double hold” mode of a control rod. In the “go” mode, fault is detected by comparing voltage ripples of a movable gripper coil, a stationary gripper coil and a lifting coil of the control rod drive mechanism. In the “hold” mode, fault is detected by means of power spectrum analysis at a predetermined frequency using a Discrete Fourier Transform (DFT) for a stationary gripper coil, and by means of a Root Means Square (RMS) calculation of coil voltage for a movable gripper coil. In the “double hold” mode, fault is detected using power spectrum analysis at a predetermined frequency using a DFT for both stationary and movable gripper coils.

### CLAIM OF PRIORITY

This application makes reference to, incorporates the same herein, and claims all benefits accruing under 35 U.S.C §119 from an application for METHOD FOR DETECTING FAULT IN POWER MODULE FOR NUCLEAR REACTOR CONTROL ROD DRIVE MECHANISM CONTROL SYSTEM, earlier filed in the Korean Intellectual Property Office on 19 Jan. 2005 and there duly assigned Serial No. 10-2005-0004833.

### BACKGROUND OF THE INVENTION

1. Technical Field

The present invention relates to a method for detecting a fault in a power module for a control system of a control rod drive mechanism of a nuclear reactor, and more particularly to a method for detecting faults of a thyristor in a power module in a “go” mode, a “hold” mode and a “double hold” mode of the control rod in the nuclear reactor.

2. Description of the Related Art

Generally, a control rod drive mechanism control system of a nuclear reactor is composed of a control cabinet which receives a command from a plant control system and transmits an operation command to power controllers, and a power cabinet for carrying out the command transmitted by the control cabinet. In the power cabinet, a three-phase half-wave rectifier is installed as a power system for operating the control rod drive mechanism having multiple coils. Electric current required for each coil is applied using the rectifier, and the control rod is inserted and withdrawn using the electric current controlled by the rectifier.

In that case, electric current flowing through each coil of the control rod drive mechanism is controlled using electric current control. If one phase of a thyristor is not fired in operation, or if the thyristor operates like a diode, operational characteristics of the control rod in a transient state deteriorate in comparison to the normal case, so that the control rod cannot be easily inserted or withdrawn. In this case, it is difficult to determine normality of the thyristor merely with coil current, and as an alternative, fault of the power module is detected using measurements of coil voltage.

In a conventional method for detecting fault of thyristors, a voltage ripple is detected during operation of the control rod, thereby deciding that there is a fault if the voltage ripple exceeds a given level. However, this method does not enable detection of a fault of a power module that supplies current to a stationary gripper coil when the control rod is in a “hold” mode, so that the control rod is apt to drop down in the end. In addition, in the case of detecting a fault using a Discrete Fourier Transform (DFT) in a “hold” mode (as disclosed in Korean Patent Application No. 10-2003-0040053), fault is not detected even though there is a fault in one of thyristors for a movable gripper coil. In addition, other methods such as a frequency spectrum analysis method (as disclosed in Korean Patent Application No. 10-2000-0049352) do not give consistent detection results during the operation of the control rod.

In a nuclear plant for base load, control rods are not frequently inserted and withdrawn, but are mainly in a “hold” mode with a state being withdrawn substantially to the maximum. In the phase fault detection method of a thyristor, in the case of the Westinghouse model, a fault of a power module is detected using a magnitude of voltage ripple that appears in a coil voltage only when the control rod is operated according to the operational command. Thus, if the control rod is in a “hold” mode, that is, a reduced current (4.4A) flows only through a stationary gripper coil, it is impossible to detect a fault in three types of power modules (for stationary, moving and lifting coils).

In addition, if a fault occurs in a thee-phase half-wave rectifier which supplies electric current to a stationary gripper coil of a Rod Cluster Control Assembly (RCCA) in a “hold” mode, the control rod is apt to fall down, and thus fault detection of the power module in a “hold” mode is essential to the control rod control system.

In addition, if a Fast Fourier Transform (FFT) is used for fault detection of a power module for a movable gripper coil in a “hold” mode, the fault detection of the power module cannot be accomplished. For example, if a “go” mode command occurs in a state in which a fault is not detected in the power module for a movable gripper coil, the control rod may fall down since current of the movable gripper coil is not sufficient to grip the control rod in the region in which current of the stationary gripper coil is 0 (zero) and electric current of the movable gripper coil is maximized during a one-step insertion/withdrawal operation.

### SUMMARY OF THE INVENTION

The present invention is designed in consideration of the problems of the prior art, and therefore it is an object of the present invention to provide a method for detecting a fault of a power module for a control system of a control rod drive mechanism of a nuclear reactor, which method enables fast fault detection and rapid management by detecting faults of the power module in all operation modes (“go”, “stationary” and “double hold” modes) of the control rod.

In order to accomplish the above object, the present invention provides a method for detecting a fault of a power module for a control system of a control rod drive mechanism of a nuclear reactor, wherein a fault of the power module is separately detected in a “go” mode, in a “hold” mode and in a “double hold” mode of the control rod.

In the latter regard, in the go mode of the control rod, a fault of the power module is detected by using voltage ripples of a movable gripper coil, a stationary gripper coil and a lifting coil of the control rod drive mechanism.

In addition, in the “hold” mode of the control rod, a fault of the power module is detected by means of power spectrum analysis at a predetermined frequency using a Discrete Fourier Transform (DFT) for a stationary gripper coil, and by means of a Root Means Square (RMS) calculation of coil voltage for a movable gripper coil.

In addition, in the “double hold” mode of the control rod, a fault of the power module is detected using power spectrum analysis at a predetermined frequency using a DFT for both stationary and movable gripper coils.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate same or similar components. Other objects and aspects of the present invention will become apparent from the following description of embodiments with reference to the accompanying drawing in which:

FIG. 1 is a schematic circuit diagram of a general three-phase half-wave rectifier composed of three thyristor power elements;

FIG. 2 is a flowchart illustrating a method for detecting a fault in a power module for a control system of a control rod drive mechanism according to the present invention;

FIG. 3 shows a test waveform in a normal state of a power module in a movable gripper coil at “hold” mode;

FIG. 4 shows a test waveform in a case in which a fault occurs in one phase of a power module for a movable gripper coil in a “hold” mode;

FIG. 5 shows a test waveform in a case in which a fault occurs in one phase of a power module for a movable gripper coil in a “double hold” mode;

FIG. 6 shows a signal waveform in the case of a maximum positive forcing in a movable gripper coil;

FIG. 7 shows a signal waveform in the case of a maximum negative forcing in a movable gripper coil; and

FIG. 8 shows a signal waveform resulting from FFT measurements in a movable gripper coil while the control rod is in operation.

### DETAILED DESCRIPTION OF THE INVENTION

Hereinafter, the present invention will be described in more detail with reference to the drawings.

In a method for detecting a fault of a power module for a control system of a control rod drive mechanism of a nuclear reactor according to the present invention, a fault of the power module is separately detected in a “go” mode, in a “hold” mode and in a “double hold” mode of a control rod.

That is to say, in the fault detection method of the present invention, fault detection is conducted separately in the “go” (insertion/withdrawal) mode, in the “hold” mode and in the “double hold” mode of the control rod so that a fault in the power module may always be detected. In the “go” mode, a fault of the power module is detected using ripple magnitude of three coil voltage waveforms. In addition, in the “hold” mode, normality of the power module for a stationary gripper coil is determined by means of the magnitude of a power spectrum at a predetermined frequency using a Discrete Fourier Transform (DFT) for voltage waveform of the coil, and normality of power module for a movable gripper coil is determined using a Root Means Square (RMS) calculation value. In addition, in the “double hold” mode, a fault is detected using a power spectrum at a predetermined frequency using a DFT for both the stationary gripper coil and the movable gripper coil.

### EXAMPLE

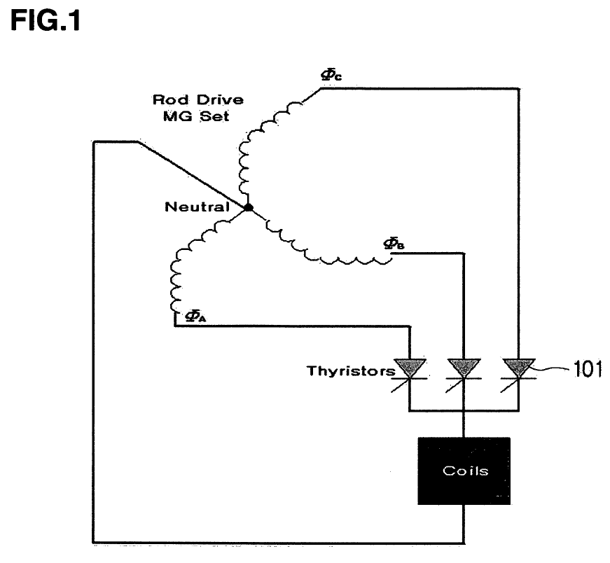

FIG. 1 is a schematic circuit diagram of a general three-phase half-wave rectifier composed of three thyristor power elements.

Referring to FIG. 1, the fault detection method of the present invention is provided in order to detect a fault of thyristors used for the three-phase half-wave rectifier by recognizing the difference in a coil voltage waveform between the case wherein the thyristors 101 for three phases are all normal and the case wherein any of the thyristors 101 is abnormal for three-phase input power.

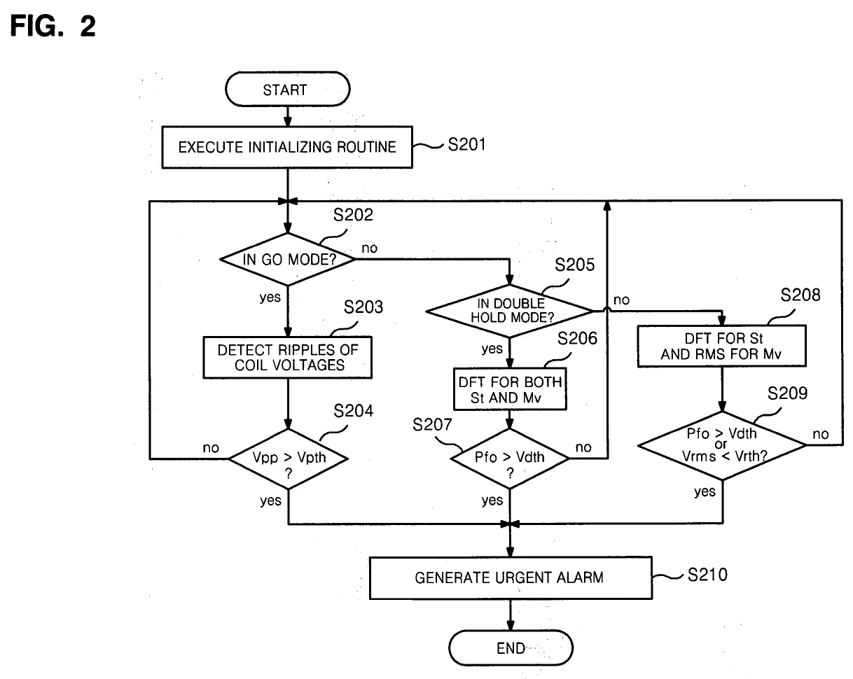

FIG. 2 is a flowchart illustrating a method for detecting a fault in a power module for a control system of a control rod drive mechanism of a nuclear reactor according to the present invention.

Referring to FIG. 2, an initializing routine is first executed (Step S201), and then a power controller determines whether a “go” command is generated from a control cabinet in an upper hierarchy (Step S202). If power controllers receive a “go” command from a logic cabinet, power controllers detect the magnitude of a ripple in coil voltage (Step S203). Then, it is determined whether the extracted ripple (Vpp) of coil voltage is greater than a given value (Vpth) (Step S204). With reference to this determination, if the magnitude of the extracted ripple (Vpp) is greater than the given value (Vpth), it is determined that a fault has occurred, and an urgent alarm is generated (Step S210). If the magnitude of the ripple is smaller than the given value, the power controller determines that no fault has occurred, and a return to repeat the detection mode is executed (Step S202).

Meanwhile, if step S202 does not determine the “go” mode, a determination is made as to whether or not a “double hold” mode exists (Step S205). If the “double hold” mode is determined, current commands of given sequences are applied to a stationary gripper coil (St) and a movable gripper coil (Mv) (Step S206), and then it is determined, using a DFT for two coil voltages, whether a fault has occurred in the power module (Step S207). Such a fault detection method of the power module using the DFT is described in more detail below.

Assuming that a sampled sequence signal is obtained by discrete operation of a rectified output voltage of a phase control rectifier into a sampling cycle (T) is f(kT), this sequence signal has a specific frequency component when the three-phase half-wave rectifier is operated normally. That is to say, if the frequency of an input AC power source is f, the three-phase half-wave rectifier has a harmonic component of an order of n·3f (n=0, 1, 2, 3, . . . ).

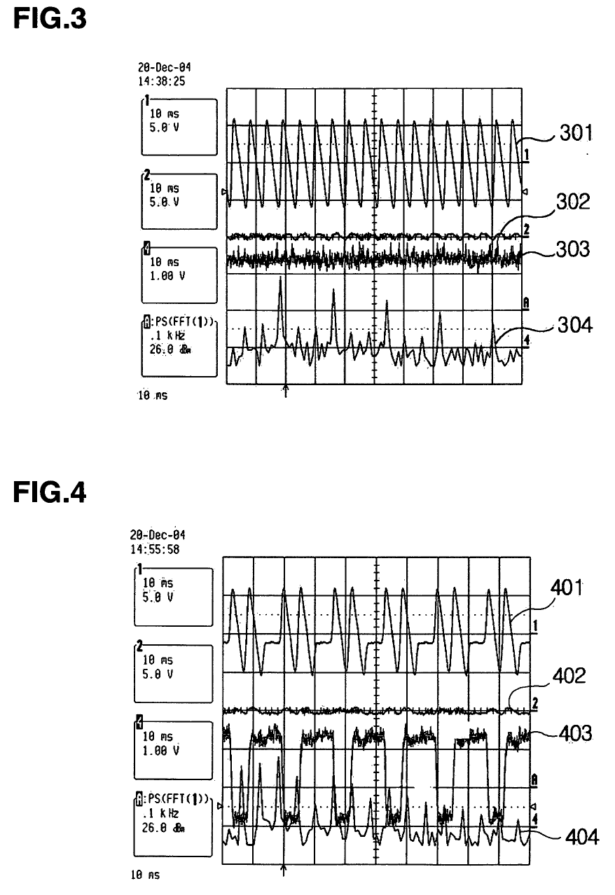

In addition, among the harmonic orders in normal operation, the 1st order or 180 Hz component has the greatest power spectrum, and the 2nd component has the next highest power spectrum (see FIG. 3). However, if a fault occurs in thyristors, a harmonic component of an order other than three-time number of the input frequency of power source is generated. This is due to the fact that the phase control rectifier is operated by using the thyristor modules fired at certain angles, and the frequency components of the output waveform are made according to the topology of switching power modules. If a fault occurs in thyristors or a gate drive circuit, the power modules are not fired at a normal period, and thus the output waveform loses normal periodicity (180 Hz) for one cycle of power source voltage, and whether or not a fault occurs is detected by means of frequency analysis. DFT may be used to extract the frequency components in coil voltages. The DFT algorithm using the N data samples may be expressed using the following equation.

$$F ( n Ω ) = {\sum }_{k = 0}^{N - 1} f ( kT ) {ⅇ}^{- f Ω Tnk} ( n = 0 , 1 , … , N - 1 )$$

where N=the number of sampled data (an even number), T=sampling cycle, and Ω=2π/NT, respectively.

In the case wherein the frequency of input power source is 60 Hz, if the sampling cycle T= 1/1800 (sec.) and DFT is executed for 30 or more, at least the frequency component for one cycle of input power source or lower than 60 Hz can be extracted.

Thus, the output F(nΩ) of an N-point DFT shows the magnitude of the frequency component as well as phase information. If the N data samples are acquired at a certain interval using the sampling cycle (T) and then they are DFT-transformed, DC component and harmonic components are extracted, from which normality of the phase control rectifier may be determined.

Returning to step S207 of FIG. 2, if the magnitude (Pfo) of the power spectrum at a specific frequency (60 Hz) is greater than a given value (Vdth), the power controller determines that a fault has occurred in the power module, and an urgent alarm is generated (Step S210).

In addition, if not in a “double hold” mode as determined in step S205, the power controller recognizes that it is in a “hold” mode, and then the DFT is applied only to the stationary gripper coil as in the “double hold” mode, and RMS is calculated for the movable gripper coil (Step S208). If the control rod is in the “hold” mode, because the movable gripper coil is doing zero-current control, and although a fault occurs in one phase of the power module, it cannot be detected by using DFT. At this point, the RMS value (Vrms) is calculated for each phase (180 Hz), and then the power controller determines that a fault has occurred in the power module for the movable gripper coil if the RMS value (Vrms) is smaller than a given value (Vrth) (Step S209), and then an urgent alarm is generated (Step S210). At this point, as for the stationary gripper coil, the DFT is applied as in the case of the “double hold” mode, and then the power controller determines that a fault has occurred in the power module for the stationary gripper coil if the magnitude (Pfo) of the power spectrum at a specific frequency (60 Hz) is greater than a given value (Vdth) (Step S209), and an urgent alarm is generated (Step S210).

Meanwhile, based on coil voltage, coil current, voltage RMS value, and FFT results for the voltage waveform of the movable gripper coil when the thyristor is normal, the changes in signals are observed when a fault occurs in the power module.

FIG. 3 shows a test waveform in a normal state of a power module in a movable gripper coil at “hold” mode. That is, it shows each signal of the movable gripper coil in the case wherein current command is applied only to the stationary gripper coil when the control rod is in a “hold” mode, coil voltage 301, coil current 302, RMS value 303, and FFT result 304 being shown from the top in FIG. 3. As shown by the FFT result 304 for voltage, the voltage signal shows the greatest power spectrum at 180 Hz if all three phases are normal.

FIG. 4 shows a test waveform in a case in which a fault occurs in one phase of a power module for a movable gripper coil in a “hold” mode.

In the case of supplying coil current by means of the three-phase half-wave rectifier using thyristors, if one of the three phases does not operate for any reason, the waveform shown in FIG. 4 is observed. As known from the RMS value 403 of FIG. 4, the RMS value is lowered substantially to zero in a 60 Hz cycle. In this case, the RMS value is lower than a given RMS threshold (Vrth in FIG. 2), and so it may be determined that a fault has occurred in any phase of the power module.

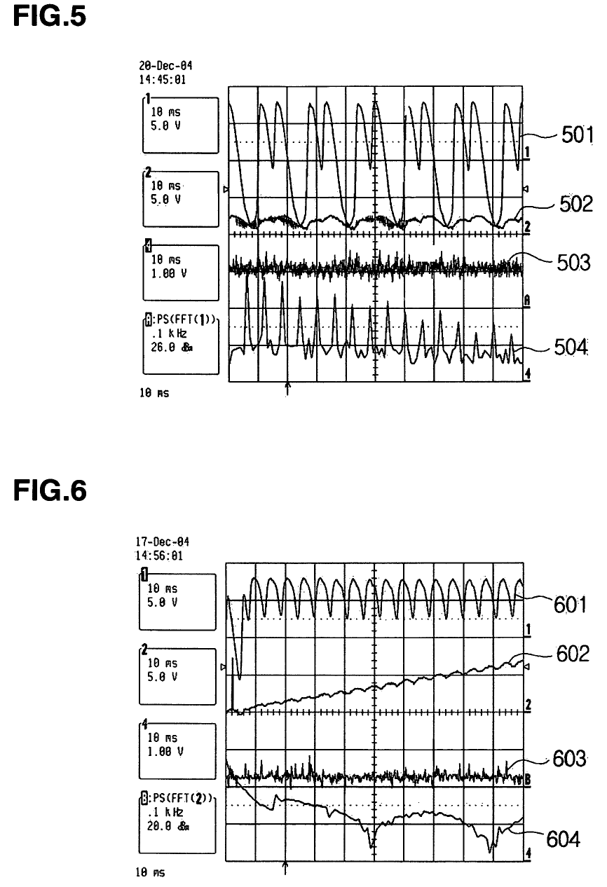

FIG. 5 shows a test waveform in a case in which a fault occurs in one phase of a power module for a movable gripper coil in a “double hold” mode. It shows signals 501-504 when a current command for the “double hold” mode is applied to the movable gripper coil in the case wherein the power controller determines an urgent fault state after detecting the state of FIG. 4, and then comes into an automatic “double hold” mode. As shown from the FFT results 504 of FIG. 5, the greatest power spectrum is formed at 60 Hz in this case, from which it is recognized that a fault has occurred in any phase of the power module.

FIG. 6 shows a signal waveform in the case of a maximum positive forcing in a movable gripper coil. It shows coil voltage 601, coil current 602, voltage RMS value 603 and FFT results 604 of the movable gripper coil for the shift of current command (Low→High) when the thyristors are normal during the “go” operation of the control rod. As shown in FIG. 6, it may be found that the ripple magnitude of the coil voltage 601 is about 5V if the thyristors are normal. Although not directly compared with FIG. 3 (FIG. 3 does not show maximum positive forcing), it may be known that the ripple magnitude is at least 10V or more in the case of a fault in which one phase is not fired.

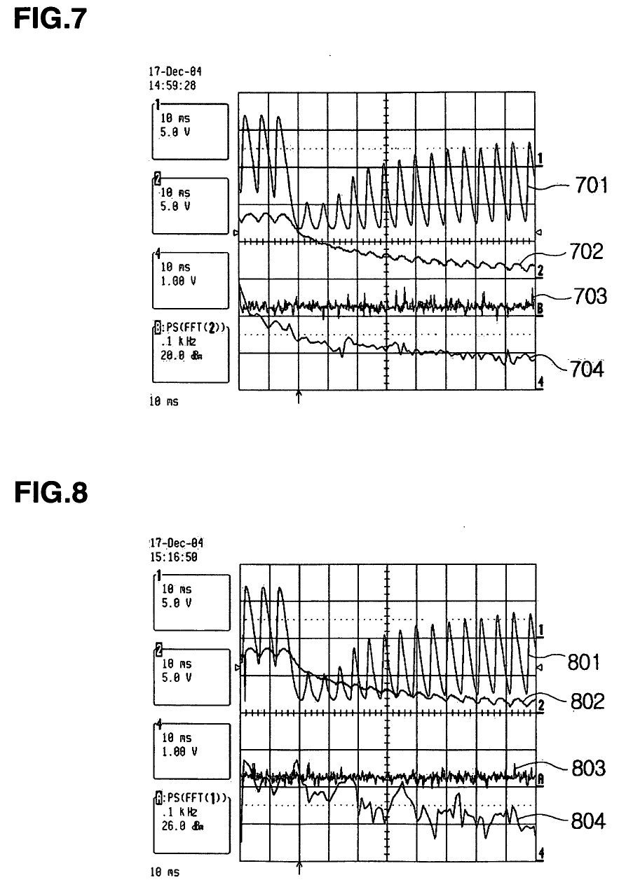

FIG. 7 shows a signal waveform in the case of a maximum negative forcing in a movable gripper coil. It is an example showing the maximum negative force for the coil current 602 in FIG. 6 in the case wherein the current command shifts from High to Low, and it shows that the maximum negative force is generated within 10 msec after the current command is shifted. At this point, the ripple magnitude is about 3V, and it is possible to determine whether a fault has occurred in the power module by means of a comparison with FIG. 3.

FIG. 8 shows a signal waveform resulting from FFT measurements in a movable gripper coil while the control rod is in operation. If a fault can be detected both in a “hold” mode and in a “go” mode of the control rod by using the above-mentioned FFT algorithm, the problem may be simply solved. However, in the case wherein the control rod is actually operated at the maximum speed (72 spm), a phenomenon appears in which the power spectrum at 60 Hz, which is generated only with a fault, is shown greatly as in FIG. 8 as an example. Since it is generated in a random manner, it is considered that determination of a fault during the “go” operation of the control rod by only FFT is very difficult. Thus, in the fault detection method of the present invention, as described above, the fault detection of the thyristors for power converter is made separately for a “go” mode, a “hold mode”, and a “double hold” mode of control rod.

As described above, the fault detection method of a power module for a control system of a control rod drive mechanism of a nuclear reactor according to the present invention detects abnormality of the power module in all of the operational modes, that is, the “go” mode, “hold” mode and “double hold” mode of the control rod, so that it is possible to prevent in advance unexpected plant failure due to malfunction of the power modules, and thus to improve availability of the nuclear power plants.

Although preferred embodiments of the present invention have been described in detail, it will be appreciated by those skilled in the art to which the present invention pertains that several modifications and variations can be made without departing from the spirit and scope of the present invention as defined in the appended claims. Accordingly, future variations of the embodiments of the present invention can be covered by the technique of the present invention.

What is claimed is:

1. A method for detecting a fault of a power module for a control system of a control rod drive mechanism of a nuclear reactor, comprising the steps of:
(a) detecting a fault of the power module in a “go” mode of the control rod; and
(b) detecting the fault of the power module in at least one of a “hold” mode and a “double hold” mode of the control rod separately from detection in the “go” mode.

2. The method of claim 1, wherein step (a) comprises comparing voltage ripples of a movable gripper coil, a stationary gripper coil and a lifting coil of the control rod drive mechanism.

3. The method of claim 1, wherein step (b) comprises detecting the fault of the power modules in the “hold” mode of the control rod by means of power spectrum analysis at a predetermined frequency using a Discrete Fourier Transform (DFT) for a stationary gripper coil, and by means of a Root Means Square (RMS) calculation of coil voltage for a movable gripper coil.

4. The method of claim 1, wherein step (b) comprises detecting the fault of the power module in the “double hold” mode of the control rod by using power spectrum analysis at a predetermined frequency using a Discrete Fourier Transform (DFT) for both a stationary gripper coil and a movable gripper coil.

5. A method for detecting a fault of a power module for a control system of a control rod drive mechanism of a nuclear reactor, comprising the steps of:
(a) detecting a fault of the power module in a “hold” mode of the control rod; and
(b) detecting the fault of the power module in at least one of a “go” mode and a “double hold” mode of the control rod separately from detection in the “hold” mode.

6. The method of claim 5, wherein step (a) comprises detecting the fault of the power modules in the “hold” mode of the control rod by means of power spectrum analysis at a predetermined frequency using a Discrete Fourier Transform (DFT) for a stationary gripper coil, and by means of a Root Means Square (RMS) calculation of coil voltage for a movable gripper coil.

7. The method of claim 5, wherein step (b) comprises detecting the fault of the power modules in the “go” mode of the control rod by comparing voltage ripples of a movable gripper coil, a stationary gripper coil and a lifting coil of the control rod drive mechanism.

8. The method of claim 5, wherein step (b) comprises detecting the fault of the power module in the “double hold” mode of the control rod by using power spectrum analysis at a predetermined frequency using a Discrete Fourier Transform (DFT) for both a stationary gripper coil and a movable gripper coil.

9. A method for detecting a fault of a power module for a control system of a control rod drive mechanism of a nuclear reactor, comprising the steps of:
(a) detecting a fault of the power module in a “double hold” mode of the control rod; and
(b) detecting the fault of the power module in at least one of a “go” mode and a “hold” mode of the control rod separately from detection in the “double hold” mode.

10. The method of claim 1, wherein step (a) comprises detecting the fault of the power module in the “double hold” mode of the control rod by using power spectrum analysis at a predetermined frequency using a Discrete Fourier Transform (DFT) for both a stationary gripper coil and a movable gripper coil.

11. The method of claim 9, wherein step (b) comprises detecting the fault of the power module in the “go” mode of the control rod by comparing voltage ripples of a movable gripper coil, a stationary gripper coil and a lifting coil of the control rod drive mechanism.

12. The method of claim 9, wherein step (b) comprises detecting the fault of the power modules in the “hold” mode of the control rod by means of power spectrum analysis at a predetermined frequency using a Discrete Fourier Transform (DFT) for a stationary gripper coil, and by means of a Root Means Square (RMS) calculation of coil voltage for a movable gripper coil.
